(19) United States
(12) Patent Application Publication
(10) Pub. No.: US 2003/0164272 A1
(43) Pub. Date: Sep. 4, 2003

(54) Wedge drum brake of a vehicle

(76) Inventor: Chong-Chul Chun, Chonrabuk-Do (KR)

Correspondence Address: Pennie & Edmonds, LLP, 3300 Hillview Avenue, Palo Alto, CA, 94304, US

(21) Appl. No.: 10/330,426

(22) Filed: Dec. 27, 2002

(30) Foreign Application Priority Data
Mar. 4, 2002 (KR) 2002-11329

(51) Int. Cl. F16D 51/00

(52) U.S. Cl. 188/343

(57) ABSTRACT

A wedge drum brake of vehicles is disclosed. A pair of pistons of a wheel cylinder are pushed out by a vertically descending wedge to make a leading shoe and a trailing shoe press against an inner circumference of a drum 10, wherein the wedge has a larger inclined angle on the side of the trailing shoe compared to the inclined angle on the side of the leading shoe and the end surfaces of the pistons facing both sides of the wedge have correspondingly different inclined angles, thereby reinforcing the expanding force of the trailing shoe so that the leading and trailing shoes have the same degree of expanding force.

### FIELD OF THE INVENTION

The present invention relates to a drum brake for a vehicle, and more particularly, to a wedge drum brake for a vehicle in which the pistons of the wheel cylinder are actuated by a wedge.

### BACKGROUND OF THE INVENTION

A conventional drum brake includes a pair of brake shoes that are hinged to a backing plate within a drum. A wheel cylinder presses the pair of brake shoes toward the inner circumference of the drum. The wheel cylinder is provided with a pair of pistons that push the brake shoes toward the inner circumference of the drum. These pistons are actuated pneumatically or hydraulically. Consequently, brake shoes are pushed outward to contact the inner circumference of the drum, thereby generating friction.

When the brake shoes generate friction against the revolving drum, they tend to revolve in the direction of the drum. The brake shoe that is pressed in the revolving direction is assisted in its braking force (this is called “self-activation”). The brake shoe that is pressed in the direction opposite to the revolving direction is inhibited in its breaking force. The brake shoe that is assisted is called the “leading shoe”, while the brake shoe that is inhibited is called “trailing shoe”.

Thus although the leading shoe and the trailing shoe receive forces of the same magnitude from the pistons, the magnitudes of the friction are different due to the assistance or inhibition from the revolving drum. Therefore, the lining of the leading shoe wears more rapidly than the lining of the trailing shoe, sometimes as much as three times more rapidly.

Accordingly, one of the linings must be more frequently replaced due to the uneven wear of the linings. This includes the troublesome task of disassembling the hub and the drum assembly when replacing the lining. In addition, in the trailing shoe, the force of the piston cannot be completely utilized due to the diminished braking force, thereby decreasing the overall performance of the drum brakes.

### SUMMARY OF THE INVENTION

The present invention provides a wedge drum brake of a vehicle, in which the expanding force of the trailing shoe is enhanced to equalize the expanding force of the leading and trailing shoes, and thereby cause the two linings to wear evenly. This eliminates the inconvenience of having to separately replace the linings and increases the braking force of the trailing shoe to improve the overall braking performance.

In accordance with a preferred embodiment of the present invention, the pair of pistons are pushed out by a wedge to cause the leading shoe and trailing shoe expand toward an inner circumference of a drum. The wedge drum brake is further characterized in that the wedge has a larger inclined angle on the side of the trailing shoe compared to the inclined angle on the side of the leading shoe; and the end surfaces of the pistons have different inclined angles the correspond to the inclined angles of the wedge.

The piston for the trailing shoe is pushed out with greater force than the piston for the leading shoe, causing both the leading and trailing shoes and corresponding lining to have the same braking force. Accordingly, the linings of the leading and trailing shoes wear out evenly and are replaced around the same time. Further the breaking force of the trailing shoe and the overall braking power is improved.

An additional preferred embodiment of the drum brake includes first and second pistons. In this embodiment a wedge with first and second sides is dimensioned and configured to exert different forces against the first and second pistons upon movement of the wedge. This brake has a leading shoe and lining, with the first piston acting against the leading shoe and lining. A trailing shoe and lining is acted upon by the second piston. The forces of the pistons cause the linings to apply a braking force to the drum. In this embodiment the different forces exerted by the wedge against the first piston and the second piston make the braking force from the leading shoe and lining substantially equal to the braking force from the trailing shoe and lining. Preferably, the movement of the wedge tends to drive the wedge between the first and second pistons and the wedge is dimensioned and configured so that this movement exerts more force against the second piston than the first piston. Also preferably, more force is exerted against the second piston because an inclined angle of the second face is greater than an inclined angle of the first face.

In a preferred embodiment of the invention the drum brake includes first and second balls with the first ball positioned between the first piston and the first side of the wedge, and the second ball positioned between the second piston and the second side of the wedge. Thus, the forces exerted by the wedge on the first and second pistons are transmitted through the first and second balls to the first and second pistons, respectively.

Preferably, the first piston has a first face and the second piston has a second face, and said first and second faces are shaped to correspond to the first and second sides of the wedge. Also preferably, the shapes of the first and second faces are flat.

### BRIEF DESCRIPTION OF THE DRAWINGS

For fuller understanding of the nature and objects of the invention, reference should be made to the following detailed description taken in conjunction with the accompanying drawings in which:

FIG. 1 is an enlarged view of the wheel cylinder portion of an edge drum brake according to a preferred embodiment of the present invention; and

FIG. 2 illustrates the actuation of the device of FIG. 1.

Like numbers refer to similar elements throughout the several drawings.

### DETAILED DESCRIPTION OF THE PREFERRED EMBODIMENT

According to a preferred embodiment of the present invention, the braking force of the trailing shoe is enhanced so that the leading and trailing shoes exert the same degree of braking force. As a result, the linings of the leading and trailing shoes wear evenly, and therefore, the two linings can be simultaneously replaced. Furthermore, the increase in the braking power of the trailing shoe may result in an increase in the overall braking power of the drum brake.

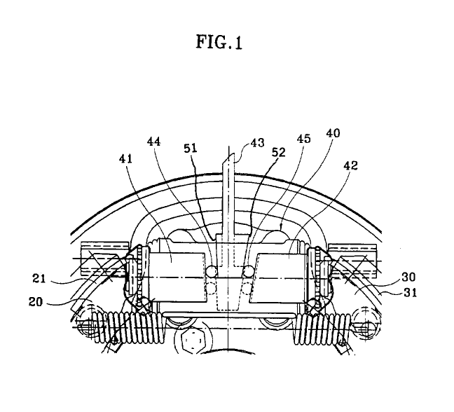

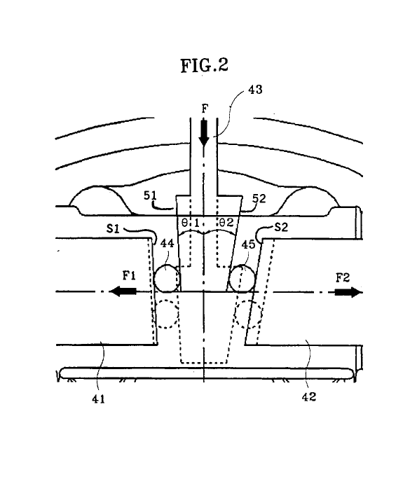

As shown in FIG. 1, in forming the inclined surfaces 51 and 52 of a wedge 43, the inclined angle of the side nearest the trailing shoe 30 is made larger than the inclined angle of the side to the leading shoe 20. As shown in FIG. 2, the inclined angles θ1 and θ2 relative to the axis of the wedge 43 are made so that θ1<θ2. The inclined angles of the end surfaces S1 and S2 of the two pistons 41 and 42 are made different to correspond to the inclined angles θ1 and θ2. Balls 44 and 45 are disposed between the wedge 43 and the pistons 41 and 42.

If the inclined angle is larger, the pushing force of the piston becomes larger, and therefore, the piston 42 and the trailing shoe 30 are pushed out with greater force than the piston 41 and the leading shoe 20. The forces F1 and F2 of the pistons 41 and 42 are F1=F/2*tan θ1 and F2=F/2*tan θ2. Therefore, if θ1<θ2, then F1<F2. One of ordinary skill in the art will know to constrain the movement of wedge 43 so that F1 and F2 do not equilibrate.

Accordingly, the value θ2 for compensating the difference between the braking force of the leading and trailing shoes 20 and 30 due to the self-activation can be obtained through experimentation or calculated based on the dynamic relations. If the value θ2 thus calculated is applied, the expanding force of the trailing shoe 30 can be increased so that the braking force of the leading and trailing shoes 20 and 30 are equal. It will be apparent to one of ordinary skill in the art how to calculate the braking forces of shoes 20 and 30 based on forces F1 and F2.

Thus, the linings 21 and 31 of the leading and trailing shoes 20 and 30 are subjected to the same amount of friction along the inner circumference of the drum 10, resulting in equal life expectancies of the linings 21 and 31 of the leading and trailing shoes 20 and 30. Accordingly, the two linings 21 and 31 can be conveniently replaced simultaneously. Furthermore, the increase in the braking force of the trailing shoe 30 causes an overall increase in the braking power.

What is claimed is:

1. A wedge drum brake, with a wedge that causes first and second pistons of a wheel cylinder to be pushed out and press a leading shoe and a trailing shoe against an inner circumference of a drum, wherein said wedge has a larger inclined angle on the side of said trailing shoe compared to the inclined angle on the side of the leading shoe.

2. The wedge drum brake as claimed in claim 1, wherein the end surfaces of the pistons face both sides of the wedge have different inclined angles and the different inclined angles correspond to the inclined angles of the side of said wedge facing each said piston.

3. A drum brake, comprising:
first and second pistons;
a drum;
a wedge with first and second sides, wherein the wedge is dimensioned and configured to exert different forces against the first and second pistons upon movement of the wedge;
a leading shoe and lining, said first piston acting against said leading shoe and lining causing a leading braking force against the drum; and
a trailing shoe and lining, said second piston acting against said trailing shoe and lining causing a trailing braking force against the drum, wherein:
the different forces exerted by the wedge against the first piston and the second piston make a the leading braking force substantially equal to the trailing braking force.

4. The drum brake of claim 3, further comprising first and second balls, the first ball positioned between the first piston and the first side of the wedge, and the second ball positioned between the second piston and the second side of the wedge, wherein the forces exerted by the wedge on the first and second pistons are transmitted through the first and second balls to the first and second pistons, respectively.

5. The drum brake of claim 3, wherein the first piston has a first face and the second piston has a second face, and said first and second faces are shaped to correspond to the first and second sides of the wedge.

6. The drum brake of claim 5, wherein the shapes of the first and second faces are flat.

7. The drum brake of claim 3, wherein movement of the wedge tends to drive the wedge between the first and second pistons and wherein the wedge is dimensioned and configured so that such movement exerts more force against the second piston than the first piston.

8. The drum brake of claim 7, wherein more force is exerted against the second piston because an inclined angle of the second face is greater than an inclined angle of the first face.
